(19) United States
(12) Patent Application Publication
(10) Pub. No.: US 2026/0006143 A1
(43) Pub. Date: Jan. 1, 2026

(54) PRINTING APPARATUS, CONTROL METHOD, AND STORAGE MEDIUM

(71) Applicant: CANON KABUSHIKI KAISHA, Tokyo (JP)

(72) Inventor: KAZUYA SATO, Kanagawa (JP)

(21) Appl. No.: 19/251,309

(22) Filed: Jun. 26, 2025

(30) Foreign Application Priority Data
Jul. 1, 2024 (JP) 2024-106067

(51) Int. Cl. H04N 1/00; G06F 3/12

(52) U.S. Cl. CPC H04N 1/00915; G06F 3/1205; G06F 3/1208; G06F 3/1211; G06F 3/1258; G06F 3/1275; G06F 3/1296; H04N 2201/0098; H04N 2201/3273

(57) ABSTRACT

One or more printing apparatuses, methods for controlling a printing apparatus, and storage mediums are provided herein. At least one object of the present disclosure is to both shorten the time required to complete cancellation of a job and prevent a decrease in print quality in a case of not canceling the job but continuing the printing. At least one embodiment of a printing apparatus may include: a display that operates to display a GUI screen including a cancellation menu screen for canceling a job; and one or more processors. In a case where the display displays the cancellation menu screen while printing based on a job is executed, the one or more processors inhibit generation of print data and inhibit print control for conveyance of a recording medium.

### BACKGROUND

### Field of the Technology

The present disclosure relates to one or more embodiments of a printing apparatus, a control method, and a storage medium. Specifically, the present disclosure relates to a technology or features for one or more embodiments of a printing apparatus including an image processing unit that performs image processing according to a job setting in response to an instruction to execute the job, and a print engine that performs printing based on print data obtained by the image processing.

### Description of the Related Art

Conventionally, printing apparatuses equipped with image processing apparatuses have a function of accepting a cancellation instruction for stopping execution of a job for which an execution instruction has been received.

For example, in a case of accepting an instruction to execute multiple jobs and canceling any of the multiple jobs, the job to be canceled is selected from a job list displayed in a cancellation menu and then the selected job is canceled. While the cancellation menu is displayed, the processing of the job is stopped, but where to stop the processing varies from one product to another.

In Japanese Patent Laid-Open No. 2008-018622, processing is continued for a currently processed page and is stopped at the beginning of the processing for the next page to the processed page.

Meanwhile, some printing apparatuses that are capable of stopping printing within a currently printed page, such as inkjet printing apparatuses and large-format printing apparatuses, stop printing within a page while displaying a cancellation menu. Also, to improve the throughput of printing, some printing apparatuses have a function to, for example, start conveying a sheet in advance while processing page data or to feed sheets such that a margin of a page being printed first is overlapped by the next page.

Here, an issue with Japanese Patent Laid-Open No. 2008-018622 is that, in a case where an instruction to stop a job is issued, it may take time to complete the processing for the currently processed page and/or the sheet for the next page has already been fed in advance, in which case it will take time to complete the cancellation.

Also, a printing apparatus which stops printing within a currently printed page stops a printing operation within a page while the cancellation menu is displayed. Thus, choosing then not to cancel the job and to continue the job may result in formation of a streak, unevenness, or the like or another similar phenomenon, which may impact the print quality.

### SUMMARY

In view of the above, at least one object of the present disclosure is to both shorten the time required to complete cancellation of a job and prevent a decrease in print quality in a case of not canceling the job but continuing the printing.

At least one embodiment of the present disclosure is a printing apparatus that may include: a display unit that operates to display a graphical user interface (GUI) screen including a cancellation menu screen for canceling a job; and a control unit that operates to, in a case where the display unit displays the cancellation menu screen while printing based on a job is executed, inhibit generation of print data and inhibit print control for conveyance of a recording medium.

According to other aspects of the present disclosure, one or more additional printing apparatuses, one or more control methods, and one or more storage mediums are discussed herein. Features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating a schematic configuration of one or more embodiments of an image processing apparatus of the present disclosure;

FIG. 2 is a flowchart of at least one embodiment of print processing involving displaying a cancellation menu that may be used in one or more embodiments of the present disclosure;

FIG. 3 is a flowchart of at least one embodiment of print processing involving displaying a cancellation menu that may be used in one or more embodiments of the present disclosure;

FIG. 4 is a flowchart of at least one embodiment of print data generation processing that may be used in one or more embodiments of the present disclosure;

FIG. 5 is a flowchart of at least one embodiment of image forming processing including print control inhibition processing that may be used in one or more embodiments of the present disclosure;

FIG. 6 illustrates at least one example of screen transitions of a GUI screen displayed on an operation panel that may be used in one or more embodiments of the present disclosure; and

FIG. 7 is at least one example of a GUI screen for setting in advance the content of processing to be performed while a cancellation menu is displayed that may be used in one or more embodiments of the present disclosure.

### DESCRIPTION OF THE EMBODIMENTS

One or more embodiments of the present disclosure will be described specifically and in detail below with reference to the accompanying drawings. It is to be noted that the following embodiment(s) is/are not intended to limit the scope of the present disclosure and the claims. Moreover, although multiple features are described in one or more of the following embodiments, not all of these features are necessarily essential to the solution(s) of the present disclosure for addressing one or more issues, and some or all of the multiple features may be combined in any ways. Furthermore, in the accompanying drawings, identical or similar components are denoted by the same reference numeral and, as a rule, overlapping description will be omitted.

### Details of One or More Embodiments

### <Configuration of Apparatus for One or More Embodiments>

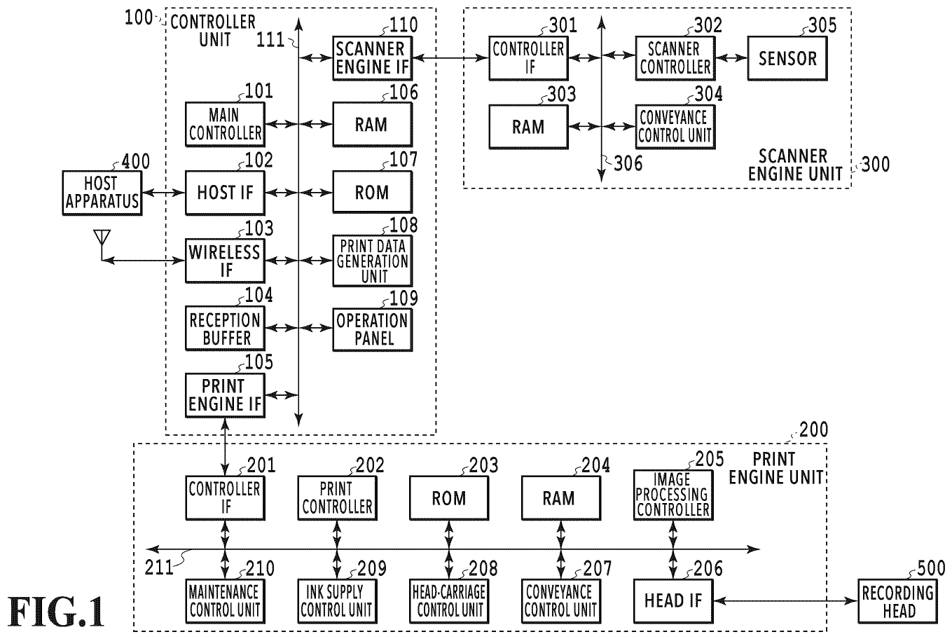

An image processing apparatus according to one or more embodiments will be described below using FIG. 1. FIG. 1 is a block diagram illustrating a schematic configuration of the image processing apparatus according to one or more embodiments. Note that the term “image processing apparatus” in one or more embodiments is a concept encompassing one or more printing apparatuses, such as inkjet printers, multi-function peripherals, and the like.

As illustrated in FIG. 1, the image processing apparatus includes a controller unit 100, a print engine unit 200, and a scanner engine unit 300. Also, the image processing apparatus is connectable to a host apparatus 400 through a host interface (hereinafter “interface” will be abbreviated as “IF”) 102 or a wireless IF 103.

The controller unit 100 has a main controller 101, a reception buffer 104, a print engine IF 105, a scanner engine IF 110, a random-access memory (RAM) 106, a read-only memory (ROM) 107, a print data generation unit 108, and an operation panel 109.

Further, the controller unit 100 has the host IF 102 and the wireless IF 103 for external connection. The components of the controller unit 100 are connected to one another through a system bus 111 and are capable of transmitting and receiving data to and from one another.

The main controller 101, which includes a central processing unit (CPU), comprehensively controls the operation of the image processing apparatus by performing printing operations and maintenance operations in accordance with programs and various parameters stored in the ROM 107 with the RAM 106 as a work area.

The image processing apparatus receives data from the host apparatus 400 through the host IF 102. This data includes jobs, such as print jobs. That is, the image processing apparatus receives jobs transmitted from the host apparatus 400 and operates based on the received jobs. The jobs received by the image processing apparatus are stored to the reception buffer 104.

In a case where a print job is stored in the reception buffer 104, the (image) data included in the print job is transmitted to the print data generation unit 108. The print data generation unit 108 then performs predetermined image processing on the received data in accordance with an instruction from the main controller 101 to generate print data. A non-volatile device, such as a hard disk drive (HDD), may be provided as the reception buffer 104, or a region for the reception buffer may be provided in a volatile device, such as a RAM.

After the print data generation unit 108 generates print data, the main controller 101 transmits the print data to the print engine unit 200 through the print engine IF 105.

Also, in a case of receiving a read command as a job from the host apparatus 400, the main controller 101 transmits the read command to the scanner engine unit 300 through the scanner engine IF 110.

The RAM 106 is, for example, used as a work area for the main controller 101 and an area to temporarily store various data, and to store various setting data. The ROM 107 stores programs to be run by the main controller 101 and various data necessary for various operations of the image processing apparatus.

The print data generation unit 108 possesses various image processing features. For example, the print data generation unit 108 performs a process of translating (converting) received data to be handled in the image processing apparatus (e.g., data represented in a page description language) into print data (bitmap image data) and other image processing. Moreover, the print data generation unit 108 converts the color space of image data included in the input received data (e.g., YCbCr) into a standard RGB color space (e.g., sRGB). Furthermore, the print data generation unit 108 performs various kinds of image processing on the receive data, such as resolution conversion into an effective number of pixels (a number with which the image processing apparatus can execute print processing), image analysis, image correction, and data compression and decompression, as necessary. The print data obtained by these kinds of image processing is then stored in the RAM 106.

The operation panel 109 includes hardware keys and a panel for the user to perform various operations, and a display unit which displays various information to the user (notifies the user of the various information). The operation panel 109 may also present information to the user by outputting a sound (such as a buzzer sound or speech) based on sound information from an audio generator.

The print engine unit 200 is a printing unit that forms images. The print engine unit 200 includes a controller IF 201, a print controller 202, a ROM 203, a RAM 204, and an image processing controller 205. The print engine unit 200 also includes a maintenance control unit 210, an ink supply control unit 209, a head-carriage control unit 208, a conveyance control unit 207, and a head IF 206 for performing various types of control.

The components of the print engine unit 200 are connected to a system bus 211, and the print engine unit 200 is connected to a recording head 500 through the head IF 206.

The print controller 202, which includes a CPU, controls various mechanisms included in the print engine unit 200 in accordance programs and various parameters stored in the ROM 203 with the RAM 204 as a work area.

In response to receiving various commands and print data through the controller IF 201, the print controller 202 temporarily stores the received various commands print data in the RAM 204.

The print controller 202 causes the image processing controller 205 to convert the stored print data into recording data so that the recording head 500 can use it in a recording operation. After the recording data is generated as a result of the conversion, the print controller 202 causes the recording head 500 to execute a recording operation based on the recording data. At this time, the print controller 202 issues a conveyance request to the conveyance control unit 207 and, in response to the request, the conveyance control unit 207 conveys a recording medium.

Print processing is executed in accordance with instructions from the print controller 202. Specifically, the recording head 500 executes the recording operation in synchronization with the operation of conveying the recording medium.

The head carriage control unit 208 changes the orientation and position of the recording head 500 according to the operating status of the image processing apparatus, such as whether the image processing apparatus is in a maintenance state or in a recording state.

The ink supply control unit 209 performs control such that the pressures of inks to be supplied to the recording head 500 stay within appropriate ranges.

The maintenance control unit 210 controls cleaning of the conveyance roller controlled by the conveyance control unit 207 and the recording head 500.

The recording head 500 is a printing unit that performs image printing, and prints an image on a recording medium based on recording data. Specifically, the recording head 500 includes recording heads for multiple colors, and the print controller 202 forms an image on a recording medium, such as a sheet, by ejecting inks from the recording heads of the respective colors in synchronization with the conveyance of the recording medium based on recording data.

Note that the description will be provided with an inkjet printer that forms images by using inks as an example of the image processing apparatus according to one or more embodiments, but the one or more embodiments of image processing apparatuses to which the present disclosure is applicable are not limited to inkjet printers. Specifically, the technology of the present disclosure is applicable to printing apparatuses of various printing methods, such as thermal printers (sublimation type, heat transfer type, etc.), dot impact printers, and electrophotographic printers, such as light emitting diode (LED) printers and laser printers.

The scanner engine unit 300 includes a controller IF 301, a RAM 303, a scanner controller 302, a conveyance control unit 304, and a sensor 305. The components of the scanner engine unit 300 are connected to one another through a system bus 306.

The main controller 101 controls hardware resources of the scanner controller 302 according to programs and various parameters stored in the ROM 107 with the RAM 106 as a work area. As a result, various mechanisms included in the scanner engine unit 300 are controlled. For example, the main controller 101 controls hardware resources of the scanner controller 302 through the controller IF 301 to convey a document set by the user via a conveyance control unit 304 and read the document with the sensor 305. The scanner controller 302 then temporarily stores data obtained by this reading (hereinafter “read data”) in the RAM 303.

Note that, in the one or more embodiments, the operation panel 109 is present in the image processing apparatus but is not limited to this configuration, and may be connected to the image processing apparatus as an external component through the host IF 102, for example. Also, the host apparatus 400 may also serve as the operation panel 109. Also, the image processing apparatus may be configured such that other input-output apparatuses can be connected thereto through the host IF 102 or the like in addition to the operation panel 109.

Also, in the one or more embodiments, print data and read data are stored in the RAM 106, the RAM 303, or the RAM 204 but may be stored in a non-volatile device, such as an HDD.

The host apparatus 400 is an external apparatus serving as a source of input data to be input into the image processing apparatus, such as print jobs. Examples of the host apparatus 400 include a personal computer (PC) with a printer driver installed therein, a server apparatus, and so on. Note that a data providing apparatus that serves as a source of data such as a digital camera or a smartphone, for example, may be provided instead of the host apparatus 400 or in addition to the host apparatus 400. The form of connection between these apparatuses and the image processing apparatus is not limited to one through the host IF 102, and they may be directly connected via wireless communication through the wireless IF 103, for example.

Note that programs for implementing functions according to the one or more embodiments may be provided to a system or apparatus through a network or various storage media. Also, a computer (such as a CPU or micro processing unit (MPU)) of that system or apparatus may read out the programs and execute the functions or cause various mechanism to execute the functions. A single computer may execute these programs, or multiple computers may cooperate with each other to execute the programs.

In addition, not all of the processes described above need to be implemented by software. Some or all of the processes may be implemented by hardware, such as an application-specific integrated circuit (ASIC).

Further, the one or more embodiments are not limited to a configuration in which a single CPU performs all processes and may employ a configuration in which multiple CPUs cooperate with each other as appropriate to perform the processes or a configuration in which a single CPU executes some processes and multiple CPUs cooperate with each other to perform the other processes.

### <Processing Executed by Image Processing Apparatus>

Processing executed by the image processing apparatus according to one or more embodiments will now be described below.

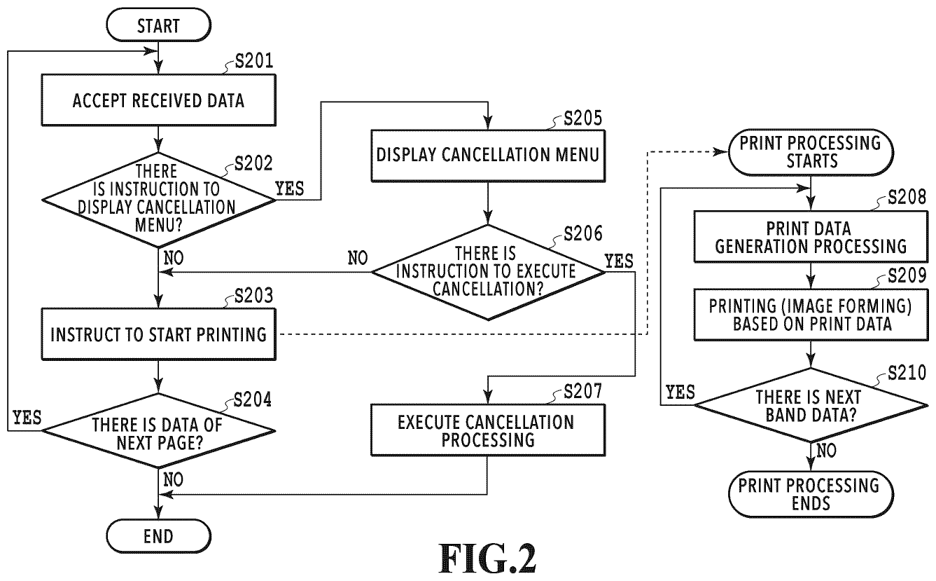

First, an issue that may arise in processing will be described using FIG. 2. FIG. 2 is a flowchart illustrating a procedure in which an image processing apparatus receives a job and performs printing based on the received job.

First, in step S201, the image processing apparatus receives data transmitted by the host apparatus 400 through the host IF 102 or the wireless IF 103, and temporarily stores the received data in the reception buffer 104. Note that the data received by the image processing apparatus in this step (e.g., a print job or the like) will be referred to as “received data.” Also, in the following, “step S_” will be abbreviated as “S_” for simplicity.

In S202, the main controller 101 determines whether the user has given an instruction to display a cancellation menu on the operation panel 109. If the result of the determination in this step is positive, the processing proceeds to S205. If the result of the determination in this step is negative, the processing proceeds to S203.

In S203, the main controller 101 issues an instruction to start printing a currently processed page to the print data generation unit 108 and the print engine IF 105. Hereinafter, the currently processed page will be referred to as “page of interest.”

In S204, the main controller 101 determines whether there is page data of a next page as data yet to be processed. If the result of the determination in this step is positive, the processing returns to S201. If the result of the determination in this step is negative, the processing is terminated.

In response to the instruction to start printing the page of interest in S203, print processing is executed. Here, “print processing” refers to the series of processes in S208 to S210. This series of processes is executed in parallel with the processes in S201 to S207, which are executed by the main controller 101. Incidentally, in FIG. 2, the dotted line indicates that the processes are executed in parallel with each other.

In S208, the print data generation unit 108 generates print data of the page of interest on a band-by-band basis, each band consisting of one or more lines.

In S209, the print controller 202 executes printing (image forming) of the page of interest on a recording medium on a band-by-band basis based on the print data generated in S208.

In S210, the print controller 202 determines whether there is data of a next unit band. If the result of the determination in this step is positive, the processing returns to S208. On the other hand, if the result of the determination in this step is negative (that is, if the printing of all bands in the page of interest is finished), the print processing of the page of interest is terminated.

As described earlier, if it is determined in S202 that there is an instruction to display the cancellation menu (YES in S202), the processing proceeds to S205. In S205, the main controller 101 displays a GUI screen of the cancellation menu on the operation panel 109. By displaying the GUI screen of the cancellation menu in this step, an instruction to execute cancellation from the user can be accepted through the cancellation menu.

In S206, the main controller 101 determines whether the user has given an instruction to execute cancellation through the cancellation menu displayed in S205. If the result of the determination in this step is positive, the processing proceeds to S207. On the other hand, if the result of the determination in this step is negative, the processing proceeds to S203, in which the main controller 101 issues an instruction to start printing of the page of interest to the print data generation unit 108 and the print engine IF 105.

In S207, the main controller 101 executes job cancellation processing. Specifically, the main controller 101 waits for cancellation of the processing for the pages included in the job that follows the page of interest and completion of the processing for the page of interest, and then completes the job cancellation processing. That is, in the above scenario, the processing for the page of interest is continued. After this step, the processing for the job by the image processing apparatus is terminated.

As described above, in the processing illustrated in FIG. 2, the page of interest for which a print start instruction is issued in S203 continues to be processed until the processing by the print data generation unit 108 and the print engine IF 105 is completed even in a case where the pages following the page of interest are canceled.

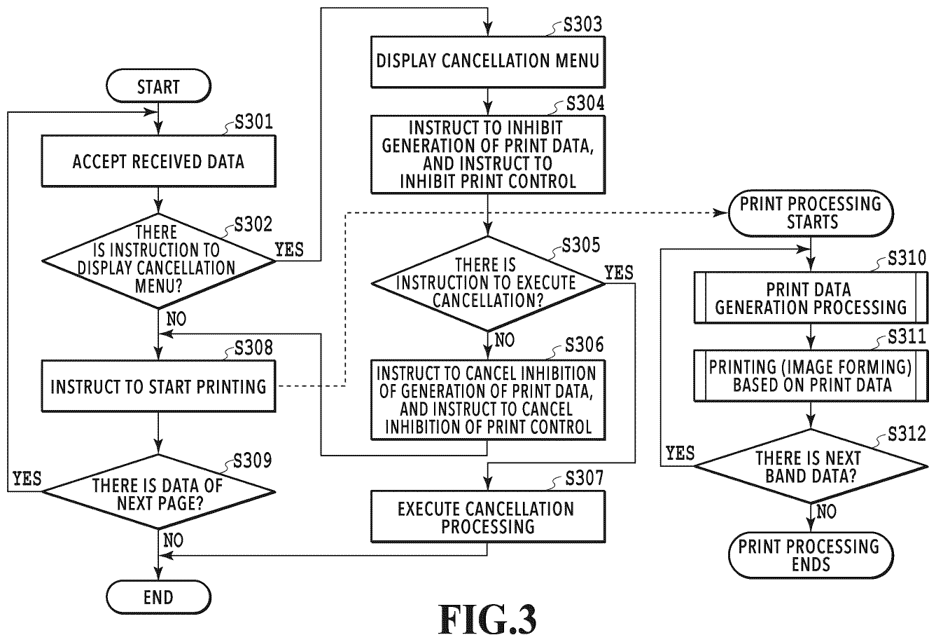

Meanwhile, iterating S201 to S204 on a band-by-band basis, instead of on a page-by-page basis, shortens the time required for the processing for the cancellation. However, the image forming processing is stopped within the page of interest while the cancellation menu is displayed. This may result in formation of a streak or unevenness or the like and impact the print quality. To address this, in one or more embodiments, the processing illustrated in FIG. 3 is executed.

FIG. 3 is a flowchart illustrating a procedure as processing according to one or more embodiments in which the image processing apparatus receives a job and performs printing based on the received job. In one or more embodiments, as will be described later, generation of print data is inhibited, and print control for sheet conveyance is inhibited (see S304).

First, in S301, the image processing apparatus receives data transmitted by the host apparatus 400 through the host IF 102 or the wireless IF 103 (obtains received data). This received data is a job, such as a print job, for example. The received data obtained in this step is temporarily stored in the reception buffer 104.

In S302, the main controller 101 determines whether the user has given an instruction to display a cancellation menu on the operation panel 109. If the result of the determination in this step is positive, the processing proceeds to S303. If the result of the determination in this step is negative, the processing proceeds to S308.

In S308, the main controller 101 issues an instruction to start printing a page of interest to the print data generation unit 108 and the print engine IF 105.

In S309, the main controller 101 determines whether there is page data of a next page as data yet to be processed. If the result of the determination in this step is positive, the processing returns to S301. If the result of the determination in this step is negative, the processing is terminated.

In response to the instruction to start printing the page of interest in S308, print processing is executed. The term “print processing” refers to the series of processes in S310 to S312. This series of processes is executed in parallel with the processes in S301 to S309, which are executed by the main controller 101. Incidentally, in FIG. 3, the dotted line indicates that the processes are executed in parallel with each other.

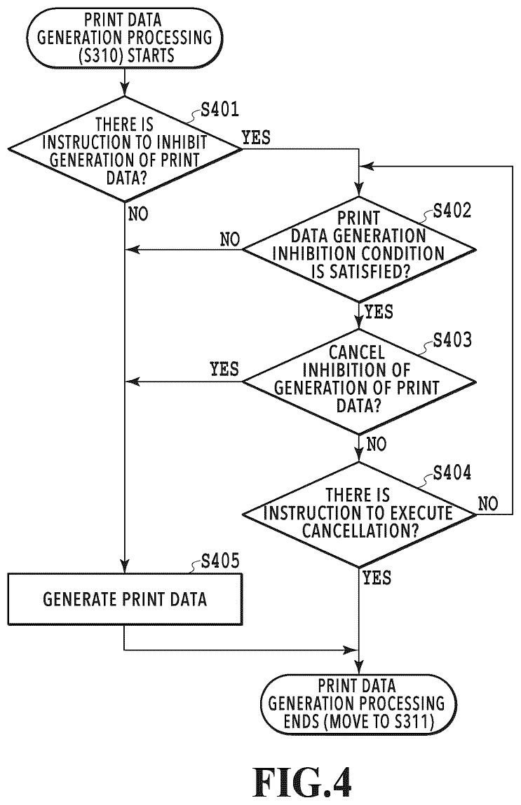

In S310, the print data generation unit 108 generates print data of the page of interest on a band-by-band basis, each band consisting of one or more lines. Details of this step will be described later with FIG. 4.

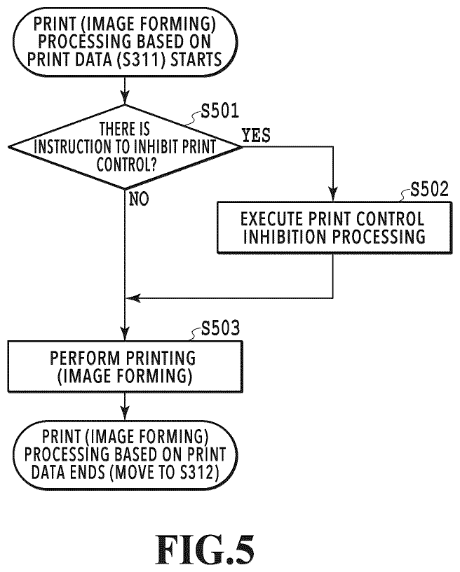

In S311, the print controller 202 executes printing of the page of interest on a band-by-band basis based on the print data generated in S310. Details of this step will be described later with FIG. 5.

In S312, the print controller 202 determines whether there is data of a next unit band. If the result of the determination in this step is positive, the processing returns to S310. On the other hand, if the result of the determination in this step is negative (that is, if the printing of all bands in the page of interest is finished), the print processing of the page of interest is terminated.

As described earlier, if it is determined in S302 that there is an instruction to display the cancellation menu (YES in S302), the processing proceeds to S303. In S303, the main controller 101 displays a GUI screen of the cancellation menu on the operation panel 109. By displaying the GUI screen of the cancellation menu in this step, an instruction to execute cancellation from the user can be accepted through the cancellation menu.

In S304, the main controller 101 issues a print data generation inhibition instruction to the print data generation unit 108. Also, the main controller 101 issues an instruction to inhibit print control for the conveyance of a recording medium (print control inhibition instruction) to the print engine unit 200 through the print engine IF 105 and the controller IF 201.

In S305, the main controller 101 determines whether the user has given an instruction to execute cancellation through the cancellation menu displayed in S304. If the result of the determination in this step is positive, the processing proceeds to S307. If the result of the determination in this step is negative, the processing proceeds to S306.

In S306, the main controller 101 issues an instruction to cancel the inhibition of execution of print data to the print data generation unit 108. Also, the main controller 101 issues an instruction to cancel the inhibition of the print control to the print engine unit 200 through the print engine IF 105. After S306, the processing proceeds to S308.

In S307, the main controller 101 executes job cancellation processing. Specifically, the main controller 101 waits for completion of cancellation of the processing for the pages included in the job that follows the page of interest and of cancellation of the processing for the page of interest, and then completes the job cancellation processing. That is, in one or more embodiments, unlike the above scenario described with reference to FIG. 2, the processing for the page of interest is not continued but is canceled. After this step, the processing for the job by the image processing apparatus is terminated.

### <Print Data Generation Processing>

The print data generation processing according to one or more embodiments (see e.g., S310 in FIG. 3) will now be described below using FIG. 4. FIG. 4 is a detailed flowchart of the print data generation processing.

In S401, the main controller 101 determines whether a print data generation inhibition instruction has been issued in S304. If the result of the determination in this step is positive, the processing proceeds to S402. If the result of the determination in this step is negative, the processing proceeds to S405.

In S402, the main controller 101 determines whether a print data generation inhibition condition is satisfied. If the result of the determination in this step is positive, the processing proceeds to S403. If the result of the determination in this step is negative, the processing proceeds to S405. The print data generation inhibition condition is determined based on a predetermined control content or contents (inhibition content or contents) indicating the extent to which to continue the processing while the cancellation menu is displayed. Examples of such control contents include the following.

A first example is control to inhibit generation of print data such that print data of a new band or line will not be generated between pages included in the currently printed job (hereinafter referred to as “inter-page inhibition control).

A second example is control to inhibit generation of print data such that print data of a new band or line will not be generated within the currently printed page included in the currently printed job (hereinafter referred to as “in-page inhibition control”).

The following are two specific examples of the in-page inhibition control. In a first example, in order to continue the printing without impairing the print quality in a case of not canceling the job but continuing it, the print data of new bands or lines continues to be generated up to a predetermined threshold value (e.g., less than or equaling the predetermined threshold value), and the print data generation is stopped in a case where the predetermined threshold value is exceeded. The predetermined threshold value is a threshold value for the number of bands or lines.

In a second example, in order to continue the printing without impairing the print quality in a case of not canceling the job but continuing it, the print data of new bands or lines continues to be generated up to a portion where the impact of stopping the printing on the image quality is low, and the print data generation is stopped in a case where the portion where the impact of stopping the printing on the image quality is low is reached.

The following are three specific examples of the inhibition control that inhibits generation of print data in a case where such a portion where the impact of stopping the printing on the image quality is low is reached. First, in a case where there is a blank region (band) extending in the main scanning direction, starting printing preceding (in the sub scanning direction) the printing of this blank region will not impact the image quality. Accordingly, print data is generated for the printing preceding the printing of the blank region.

Second, in a case where there is a region (band) extending in the main scanning direction where the color appearance is lower than a predetermined threshold value (i.e., the color is faint), starting printing preceding (in the sub scanning direction) the printing of the region with the faint color will not impact the image quality. Accordingly, print data is generated for the printing preceding the printing of the region with the faint color.

Third, in a case where there regions (bands) extending in the main scanning direction that have different colors, starting printing preceding (in the sub scanning direction) the printing of the regions with the different colors will not impact the image quality. Accordingly, print data is generated for the printing preceding the printing of the regions with the different colors.

The user selects at least one of the contents listed above, and the print data generation inhibition condition to be used in S402 is determined based on the at least one selected content. Note that the control contents listed above are exemplary, and other examples may be employed.

In S403, the main controller 101 determines whether an instruction to cancel the inhibition of print data generation has been issued. If the result of the determination in this step is positive, the processing proceeds to S405. If the result of the determination in this step is negative, the processing proceeds to S404.

In S404, the main controller 101 determines whether an instruction to cancel the job has been issued. If the result of the determination in this step is positive, the print data generation processing is terminated, and the processing proceeds to S311. If the result of the determination in this step is negative, the processing proceeds to S402.

In S405, the print data generation unit 108 generates print data. After this step, the print data generation processing is terminated, and the processing proceeds to S311.

FIG. 5 is a detailed flowchart of the printing (image forming processing) based on the print data in S311 in FIG. 4.

In S501, the print controller 202 determines whether a print control inhibition instruction has been issued by the main controller 101 and received through the print engine IF 105 and the controller IF 201 in S304. If the result of the determination in this step is positive, the processing proceeds to S502. If the result of the determination in this step is negative, the processing proceeds to S503.

In S502, the print controller 202 executes print control inhibition processing. Examples of the specific contents of the print control inhibition processing executed in this step include the following.

A first example is advance sheet feed inhibition processing that prevents execution of sheet feed in advance of the generation of the print data. A second example is overlapping consecutive sheet conveyance inhibition processing that prevents consecutive sheet conveyance with overlap with the next page that is performed to improve the throughput of continuous printing. A third example is print rate reduction processing that lowers the print rate to such an extent as not to impact the print quality, and is specifically processing that lowers the scan speed of the recording head 500 and/or the conveyance speed of the recording medium. Note that one or more embodiments may use a combination of the three contents listed above, but one or more embodiments may use at least one of these selected by the user or use contents other than the above three.

In S503, the print controller 202 generates recording data based on the print data and executes image forming processing based on the generated recording data with the recording head 500.

### <Display Example of Cancellation Menu>

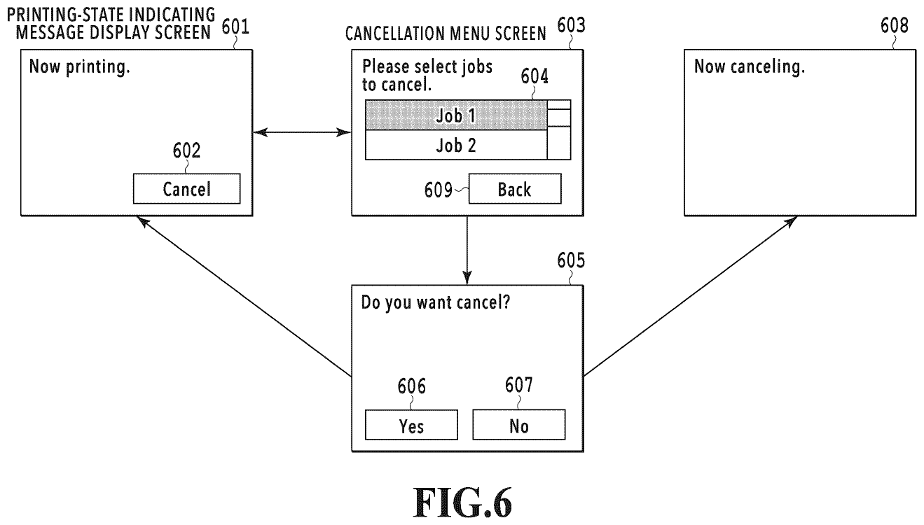

FIG. 6 exemplarily illustrates screen transitions of a GUI screen displayed on the operation panel 109, where the GUI screen includes a screen with a cancellation menu and a screen to accept a cancellation instruction.

A printing-state indicating message display screen 601 is a screen that is displayed when it is determined in S302 described earlier (see FIG. 3) whether there is an instruction to display a cancellation menu. In a case where the user presses a cancel button 602, it is determined that there is an instruction to display a cancellation menu, and a cancellation menu screen 603 is displayed in S303.

The cancellation menu screen 603 has a job list 604 and a “Back” button 609. The user selects one or more jobs to cancel from among the jobs in the job list 604. In a case where the user selects one or more jobs from the job list 604, a cancellation confirmation screen 605 is displayed in place of the cancellation menu screen 603. On the other hand, in a case where the user presses the “Back” button 609 without selecting a job from among the jobs in the job list 604, the printing is continued. In this case, the printing-state indicating message display screen 601 is displayed in place of the cancellation menu screen 603.

The cancellation confirmation screen 605 has “Yes” button 606 and “No” button 607. By pressing the “Yes” button 606, the user gives an instruction to cancel the jobs selected from the job list 604 (YES in S305 in FIG. 3). In this case, cancellation processing is executed in S307. While the cancellation processing is executed, a canceling-state indicating message display screen 608 is displayed in place of the cancellation confirmation screen 605.

On the other hand, in a case where the user presses “No” button 607, the selected jobs are not canceled and the printing is continued. In this case, the printing-state indicating message display screen 601 is displayed in place of the cancellation confirmation screen 605.

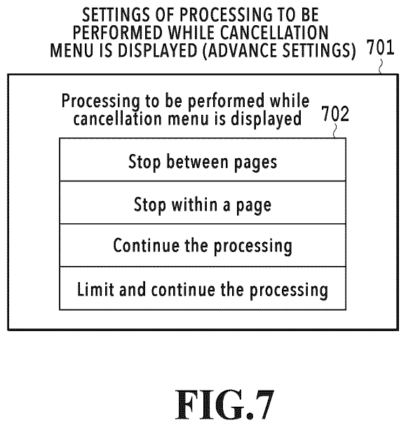

FIG. 7 illustrates an example of a GUI screen that is displayed on the operation panel 109 for selectively setting operations to be performed while the cancellation menu is displayed.

On a while-cancellation-menu-is-displayed processing setting screen 701, the user can select a desired option from among options 702 each indicating an extent to which to advance the job processing while the cancellation menu is displayed to thereby set in advance the operation to be performed while the cancellation menu is displayed. The user can select, for example, control with any of following contents as below with the options 702.

In FIG. 7, “Stop between pages” refers to control which stops the processing between pages. “Stop within a page” refers to control which is employed to control one or more inkjet printing apparatuses and large-format printing apparatuses and forcibly stops the processing within the currently printed page. “Continue the processing” refers to control which continues the processing in a usual manner (i.e., without restrictions) even while the cancellation menu is displayed. “Limit and continue the processing” refers to the control, which limits (inhibits) and continues the processing, according to one or more features that may be used in one or more embodiments of the present disclosure.

### Effect(s) of One or More Embodiments

As described above, in one or more embodiments, while the cancellation menu is displayed, the generation of print data is inhibited and the print control for the sheet conveyance is inhibited. This makes it possible to both shorten the time required to complete cancellation of a job and prevent a decrease in print quality in a case of not canceling the job but continuing the printing.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to both shorten the time required to complete cancellation of a job and prevent a decrease in print quality in a case of not canceling the job but continuing the printing.

While the present disclosure has been described with reference to one or more exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to and the benefit of Japanese Patent Application No. 2024-106067, filed Jul. 1, 2024, which is hereby incorporated by reference herein in its entirety.

1. A printing apparatus comprising:
a display unit that operates to display a GUI screen including a cancellation menu screen for canceling a job; and
a control unit, wherein
in a case where the display unit displays the cancellation menu screen while printing based on a job is executed, the control unit operates to inhibit generation of print data and inhibit print control for conveyance of a recording medium.

2. The printing apparatus according to claim 1, further comprising a print data generation unit that operates to generate the print data based on a job, wherein
the control unit further operates to instruct the print data generation unit to inhibit the generation of the print data.

3. The printing apparatus according to claim 2, wherein:
(i) the inhibition of the generation of the print data includes:
an inter-page inhibition which inhibits generation of print data of a new band or line between pages included in a currently printed job, and
an in-page inhibition which inhibits generation of print data of a new band or line within a currently printed page included in a currently printed job; and
(ii) a user selects at least one of the inter-page inhibition and/or the in-page inhibition.

4. The printing apparatus according to claim 3, wherein the in-page inhibition includes:
a first inhibition which continues generation of print data of new bands or lines up to a predetermined threshold value, and inhibits the generation of the print data in a case where the predetermined threshold value is exceeded, and
a second inhibition which continues generation of print data of new bands or lines up to a portion where an impact of stopping the printing on image quality is lower than a second predetermined threshold, and inhibits the generation of the print data in a case where the portion where the impact of stopping the printing on the image quality is lower than the second predetermined threshold is reached.

5. The printing apparatus according to claim 4, further comprising a printing unit that operates to performing processing for forming an image on the recording medium, wherein
the control unit further operates to instruct the printing unit to inhibit the print control.

6. The printing apparatus according to claim 5, wherein:
the inhibition of the print control includes an advance sheet feed inhibition, an overlapping consecutive sheet conveyance inhibition, and a print rate reduction, and
a user selects at least one of the advance sheet feed inhibition, the overlapping consecutive sheet conveyance inhibition, and/or the print rate reduction.

7. The printing apparatus according to claim 6, wherein:
the cancellation menu screen includes a job list, and
a user selects a job to cancel from among jobs in the job list.

8. The printing apparatus according to claim 7, wherein:
(i) the GUI screen includes a while-cancellation-menu-is-displayed processing setting screen for setting an extent to which to advance job processing while a cancellation menu is displayed, and
(ii) on the while-cancellation-menu-is-displayed processing setting screen, a user selects any of the following:
a first control which stops the processing between pages,
a second control which forcibly stops the processing within a currently printed page,
a third control which continues the processing in a usual manner, or
a fourth control which limits and continues the processing.

9. A method of controlling a printing apparatus including a display unit that operates to display a GUI screen including a cancellation menu screen for canceling a job, and a control unit, the method comprising:
in a case where the display unit displays the cancellation menu screen while printing based on a job is executed, causing the control unit to inhibit generation of print data and inhibit print control for conveyance of a recording medium.

10. A non-transitory computer readable storage medium storing a program which causes a computer to execute a method of controlling a printing apparatus including a display unit that operates to display a GUI screen including a cancellation menu screen for canceling a job, and a control unit, the method comprising:
in a case where the display unit displays the cancellation menu screen while printing based on a job is executed, causing the control unit to inhibit generation of print data and inhibit print control for conveyance of a recording medium.
